(19) United States
(12) Patent Application Publication
(10) Pub. No.: US 2007/0188577 A1
(43) Pub. Date: Aug. 16, 2007

(54) Printing apparatus, gravure printing method and method of manufacturing display device using same

(76) Inventors: Jin-kyung Choi, Seoul (KR); Byoung-Joo Kim, Gyeonggi-do (KR); Jin-seuk Kim, Daejeon (KR)

Correspondence Address: MACPHERSON KWOK CHEN & HEID LLP, 2033 GATEWAY PLACE, SUITE 400, SAN JOSE, CA, 95110, US

(21) Appl. No.: 11/701,661

(22) Filed: Feb. 1, 2007

(30) Foreign Application Priority Data
Feb. 3, 2006 (KR) 2006-0010807

(51) Int. Cl. B41J 2/01

(52) U.S. Cl. 347/103

(57) ABSTRACT

The present invention relates to a gravure printing method comprising providing a printing substrate where a plurality of recessed cells are formed adjacently each other; filling the recessed cells with ink using an ink jet apparatus which includes a plurality of nozzle heads to jet different colors of inks; and transferring the ink in the recessed cells to an insulating substrate. Thus, the present invention provides a gravure printing method which has a simple process and an improved yield.

### CROSS-REFERENCE TO RELATED APPLICATIONS

This application claims the benefit of Korean Patent Application No. 2006-0010807, filed on Feb. 3, 2006, in the Korean Intellectual Property Office, which is hereby incorporated by reference for all purposes as if fully set forth herein.

### BACKGROUND

1. Field of the Invention

The present invention relates to a printing apparatus, a gravure printing method and a method of a manufacturing display device using the same.

2. Description of the Related Art

Flat panel display devices have been popular because of their small size and light weight. The flat panel display device includes a liquid crystal display (LCD), and a back lighting unit such as an organic light emitting diode (OLED) or the like. The LCD displays images by controlling the light transmittance of the liquid crystal molecules in a matrix array according to an image signal.

The LCD panel includes a thin film transistor (TFT) substrate where TFTs are formed, a color filter substrate where color filters are formed, and a liquid crystal layer disposed therebetween.

The LCD is manufactured by a gravure printing method in which ink is applied to a plurality of recessed cells formed in a printing substrate with a blade. The ink in the recessed cells is transferred to an insulating substrate on which a black matrix is disposed to form a color filter layer.

In the gravure printing method different colors of ink, such as red, green or blue, fill the respective recessed cells and are transferred to regions between the black matrixes to form the color filter layers. Because, different colors may not formed at the same time since the colors may be mixed with each other thereby making the process complicated and time consuming.

### SUMMARY

According to one aspect of the present invention a gravure printing method which is simple process and which results in an improved yield comprising filling the recessed cells of a printing substrate with ink using an ink jet apparatus having a plurality of nozzle heads to jet different colors of ink; and transferring the ink in the recessed cells to an insulating substrate.

According to another embodiment of the invention, the ink in the recessed cells is transferred to a roller by rolling the roller on the surface of the printing substrate; and transferring the ink on the roller to the insulating substrate.

According to another embodiment of the invention, the ink jet apparatus comprises a plurality of nozzle units that move over the printing surface to fill the recessed cells with red ink, green ink and blue ink, respectively.

According to another embodiment of the invention, the gravure printing method further comprises flattening the ink on the surface of the printing substrate after filling the recessed cells with the ink by progressing a flattening plate closely to the surface of the printing substrate.

According to another embodiment of the invention, the flattening plate progresses parallel with the extending direction of the recessed cells.

According to another embodiment of the invention, the flattening plate comprises a blade.

According to another embodiment of the invention, the different colors of inks have such a viscosity as not to mix with each other when filling in the recessed cells.

According to another embodiment of the invention, the different colors of inks are injected from the plurality of nozzle heads to the recessed cells at such pressure that the different colors of inks do not mix with each other when filling in the recessed cells.

According to an embodiment of the invention, there is provided a manufacturing method of a display device comprising providing a printing substrate where a plurality of recessed cells are formed adjacently each other; filling the recessed cells with ink using an ink jet apparatus which includes at least one nozzle head; and transferring the ink in the recessed cells to an insulating substrate.

According to another embodiment of the invention, the recessed cells comprises a first through third recessed cells disposed along a first through third lines respectively, and different colors of inks are filled in the first through third recessed cells at the same time or sequentially.

According to another embodiment of the invention, a black matrix having an opening pattern is provided on the insulating substrate, and the ink in the recessed cells is transferred to the opening pattern.

According to another embodiment of the invention, the transferring the ink to the insulating substrate comprises transferring the ink in the recessed cells to a roller by the roller progressing closely to a surface of the printing substrate; and transferring the ink on the roller to the opening pattern.

According to another embodiment of the invention, the manufacturing method further comprises flattening the ink on the surface of the printing substrate and removing the ink disposed outside of the recessed cells by progressing a flattening plate closely to the surface of the printing substrate after filling the recessed cells with the ink.

According to an embodiment of the invention, there is provided a printing apparatus comprising a stage including a seating region where a printing substrate with a plurality of recessed cells is seated; an ink jet apparatus including a plurality of nozzle heads to jet ink to the recessed cells; a roller transferring the ink in the recessed cells to an insulating substrate; a first through third driving parts to drive the stage, the ink jet apparatus and the roller respectively; and a controller to control the first through third driving parts.

According to another embodiment of the invention, the printing apparatus further comprises a flattening plate which flattens the ink in the recessed cells and removes ink overflowed outside the recessed cells; and a fourth driving part to drive the flattening plate, wherein the controller controls the fourth driving part.

According to another embodiment of the invention, the recessed cells comprises a first through third recessed cells provided along a first through third lines, and the ink jet apparatus jets different colors of inks to the first through third recessed cells at the same time.

According to another embodiment of the invention, the recessed cells comprises a first through third recessed cells provided along a first through third lines, and the ink jet apparatus jets different colors of inks to the first through third recessed cells in a separate process, respectively.

According to another embodiment of the invention, the ink jet apparatus jets the ink from the plurality of nozzle heads to the recessed cells at such pressure that the different colors of inks do not mix with each other when filling in the recessed cells.

According to another embodiment of the invention, the ink jet apparatus jets the ink from the plurality of nozzle heads to the recessed cells at such pressure that the different colors of inks do not mix with each other when filling in the recessed cells.

Additional features of the invention will be set forth in the description which follows, and in part will be apparent from the description, or may be learned by practice of the invention.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIGS. 1 through 5 illustrate a gravure printing method according to an exemplary embodiment of the present invention.

FIGS. 6 and 7 illustrate a manufacturing method of a display device according to the exemplary embodiment of the present invention.

FIGS. 8 and 9 illustrate a printing apparatus according to the exemplary embodiment of the present invention.

Embodiments of the present invention and their advantages are best understood by referring to the detailed description that follows. It should be appreciated that like reference numerals are used to identify like elements illustrated in one or more of the figures. It should also be appreciated that the figures may not be necessarily drawn to scale.

### DETAILED DESCRIPTION

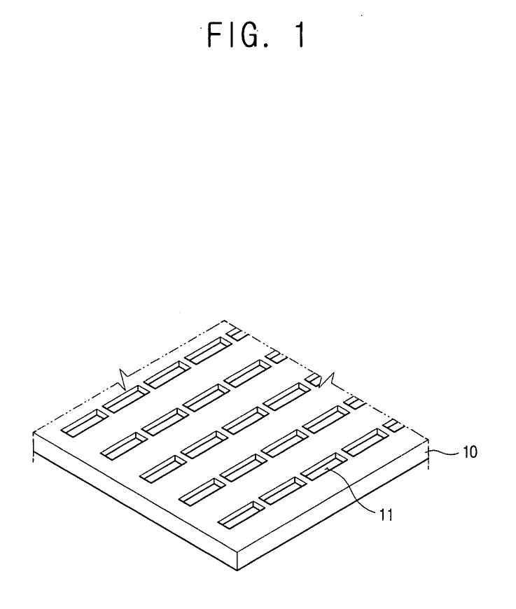

Hereinafter, a gravure printing apparatus and a gravure printing method according to an exemplary embodiment will be described with reference to FIGS. 1 through 5.

Referring to FIG. 1, a printing substrate 10 is prepared. A plurality of recessed cells 11 are arranged in parallel on the printing substrate 10. The recessed cells 11 are concave having a predetermined depth. The width, the length and the depth of the recessed cells 11 are substantially the same as the width, the length and the height of a pattern to be formed and are arranged to correspond to the arrangement of the pattern.

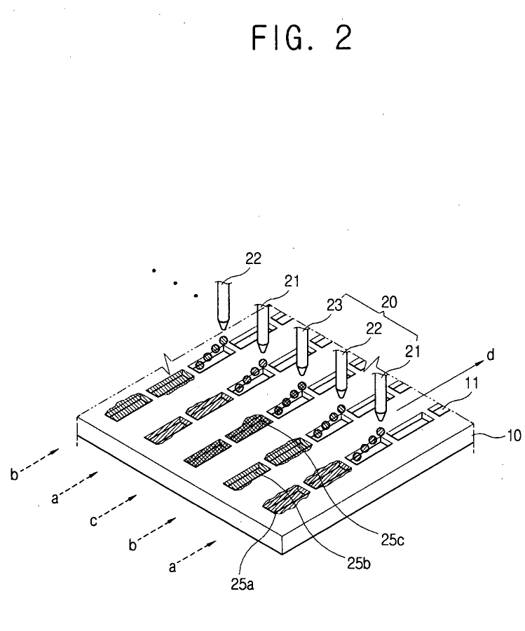

Referring to FIG. 2, an ink-jet apparatus 20 fills the recessed cells 11 with ink 25a, 25b and 25c from a plurality of nozzle unit heads 21, 22 and 23 each jetting a different color inks. For example, nozzle head 21 jets red ink 25a, nozzle head 22 jets green ink 25b, and nozzle head 23 jets blue ink 25c. The recessed cells 11 include first recessed cells disposed along a first line (a), second recessed cells disposed along a second line (b), and third recessed cells disposed along a third line (c). The first through third recessed cells are disposed repeatedly without changing their sequence. The first through third nozzle heads 21, 22 and 23 operate along the first through third recessed cells.

According to the size of the ejecting hole 24, the nozzle heads 21, 22 and 23 may jet the ink 25a, 25b and 25c in discontinuous droplets or continuously. The size of the ejecting hole 24 may be properly adjusted depending on the viscosity of the ink 25a, 25b and 25c and the jetting pressure. For example, the size of the ejecting hole 24 of the first through third nozzle heads 21, 22 and 23 according to the present exemplary embodiment may be larger than that of a nozzle head used for a conventional ink-jet method. In the conventional ink-jet method, the size of an ejecting hole is made small and a small amount of ink is jetted several times. This is necessary since a misplaced or spilled or splashed spot may be recognized on a display panel unless the jetting position of ink and the ejecting amount thereof are properly and accurately controlled. In the present exemplary embodiment, however, the jetting position of the ink 25a, 25b and 25c and the ejected amount thereof need not be precisely controlled because any ink outside of the recessed cells 11 is removed by a blade to form a smooth surface after recessed cells 11 have been filled with ink Thus, the probability of perceiving a splashed or spilled or misplaced spot on the display panel is reduced. Further, in the present exemplary embodiment, the jetting position and the jetting amount are not required to be as accurate as those in the conventional ink-jet method, the jetting speed can be increased to reduce processing time and enhance yield.

It is preferred that the inks 25a, 25b and 25c should not be in a liquid state but should be in a gel state having a predetermined viscosity so that the inks 25a, 25b and 25c are transferred to fill recessed cells 11 while maintaining a predetermined shape. Accordingly, the viscosity of the inks 25a, 25b and 25c jetted from the nozzle heads 21, 22 and 23 is higher than that of the ink used in the conventional ink-jet method in order to minimize the possibility of mixing the different colors of inks that are jetted at the same time. The higher viscosity will prevent the different colors of ink 25a, 25b and 25c jetted from the nozzle heads 21, 22 and 23 from splashing or flowing into the wrong ones of recessed cells 11. Moreover, the high viscosity of the inks 25a, 25b and 25c allows the jetted droplets to maintain their shapes during jetting. Thus, the amount of inks 25a, 25b and 25c that could possibly splash or flow into the improper cells 11 is reduced.

Further, the different colors of inks 25a, 25b and 25c are preferably jetted to the recessed cells at such pressure that the different colors of inks may not be mixed each other. Jetting pressure may be adjusted according to the size of the ejecting hole 24 and the viscosity of the inks 25a, 25b and 25c.

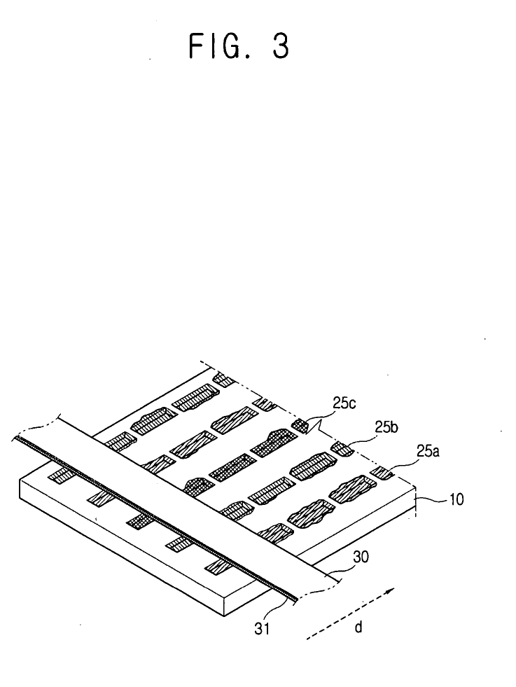

Referring to FIG. 3, a flattening plate 30 is positioned on one side of the printing substrate 10 and moved along the surface of printing substrate 10 to flatten the inks 25a, 25b and 25c and remove any of the ink that may have overflowed from the recessed cells 11. Thus, the inks 25a, 25b and 25c do not spread or flow into the wrong ones of recessed cells 11 even though the recessed cells 11 are filled close to the surface of the printing substrate. The flattening plate 30 has a rectangular shape wide enough to cover one side of the printing substrate 10 and includes a contacting part 31 having a soft material such as rubber or silicon at contacting portion with the surface of the printing substrate 30. The contacting part 31 removes any of the ink that may have overflowed the recessed cells 11.

Preferably, the flattening plate 30 moves in an extending direction (d) of the recessed cells 11 so that the different colors of inks 25a, 25b and 25c filled in the respective recessed cells 11 may not mix with each other. If the flattening plate 30 moves along the surface of the printing substrate 10 at an angle away from extending direction (d) of the recessed cells there is the possibility that ink disposed in the first line (a) may be driven into the second recessed cells in the second line (b), thereby resulting in the undesirable mixing of different colors of ink. The flattening plate 30 may include a blade.

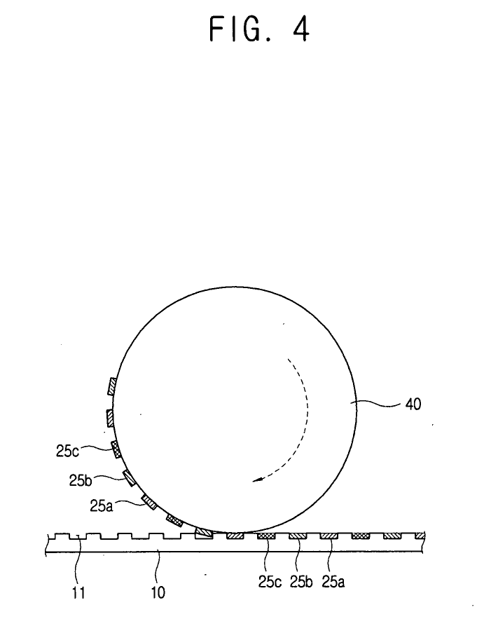

Referring to FIG. 4, the different colors of inks 25a, 25b and 25c that have been uniformly filled in the recessed cells 11 are transferred to roller 40 that moves closely over the surface of the printing substrate 10. The transfer of ink to roller 40 obeys the following principle: when the surface tension or frictional force of the surface of the recessed cells 11 is smaller than that of the inks 25a, 25b and 25c and surface tension or frictional force of the roller 40 is larger than the that of the inks 25a, 25b and 25c, the inks 25a, 25b and 25c in the recessed cells 11 is transferred to the roller 40. Alternatively, when the surface of the recessed cells 11 is charged with positive or negative charge and the inks 25a, 25b and 25c are charged with the same charge as the surface of the recessed cells 11, the repulsive force tends to cause the inks 25a, 25b and 25c to be separated from the surface of the recessed cells 11. When the roller 40 has a charge that is opposite to the charge on any of inks 25a, 25b and 25c, the inks 25a, 25b and 25c are transferred to the roller 40. Ink will also be transferred to roller 40 if the inks 25a, 25b and 25c and the surface of the recessed cells 11 are charged with the same positive or negative charge and the roller 40 is charged opposite thereto. Ink may be easily transferred to the roller 40 when the inks 25a, 25b and 25c are charged more intensively than the surface of the recessed cells 11 so that force between the inks 25a, 25b and 25c and the roller 40 is stronger than force between the surface of the recessed cells 11 and the roller 40.

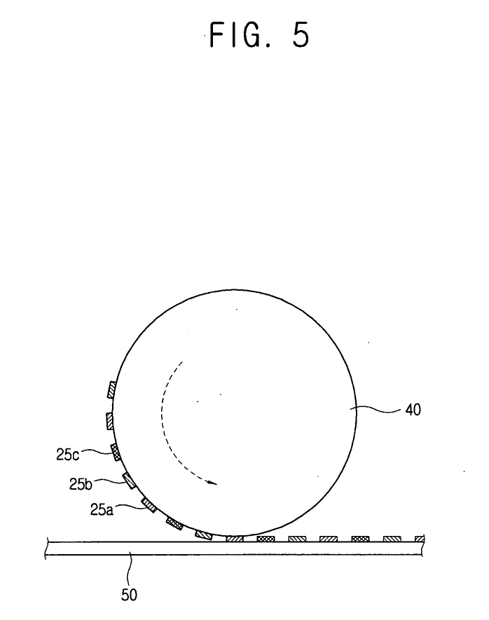

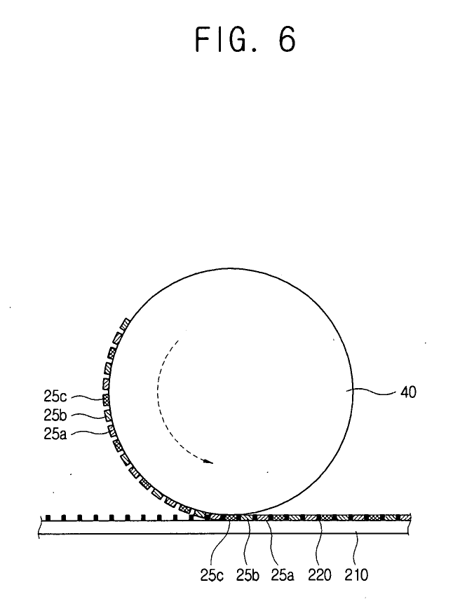

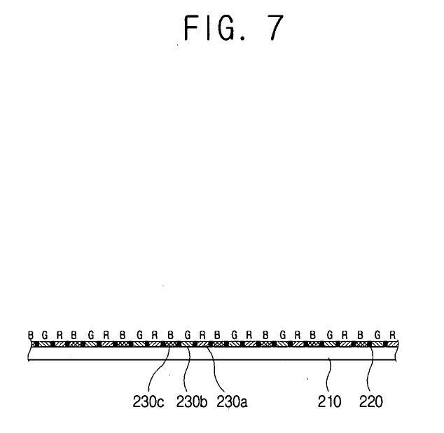

Referring to FIG. 5, the roller 40 with the inks 25a, 25b and 25c thereon moves to transfer the inks 25a, 25b and 25c to a predetermined position on an insulating substrate 50, thereby forming a pattern. The inks 25a, 25b and 25c may be transferred by the aforementioned principles.

Accordingly, the different colors of inks 25a, 25b and 25c may easily be transferred to the insulating substrate 50 without mixing with each other, thereby forming the pattern on the insulating substrate 50. Further, the different colors inks 25a, 25b and 25c are transferred to the insulating substrate 50 at the same time, thereby simplifying the process, reducing processing hour and minimizing color mixing, and thus enhancing a yield of a printing process.

An LCD panel includes a TFT substrate, a color filter substrate facing the TFT substrate, and a liquid crystal layer disposed therebetween.

The color filter substrate includes an insulating substrate 210, a black matrix 220 and a common electrode. The insulating substrate 210 includes insulating materials such as glass, quartz, ceramic or plastic and a color filter layer 230a and 230b. The color filter layers 230a and 230b have red, green and blue color filters or cyan, magenta and yellow color filters. The black matrix 220 is formed between the color filters 230a and 230b, and the common electrode is formed on the black matrix 220 and the color filter layer 230a and 230b.

The black matrix 220 is disposed between the color filters 230a and 230b having different colors such as red, green and blue or cyan, magenta and yellow to divide therebetween.

Hereinafter, a manufacturing method of a display device using the aforementioned gravure printing method will be described with reference to drawings in detail. It should be noted that the following description will be made to only different features from those of the gravure printing method, and description to the remaining similar features will not be repeated herein. The inks described in FIGS. 1 through 5 correspond to a color filter ink.

A manufacturing method of a color filter layer 230a, 230b and 230c using the gravure printing method will be described with reference to FIGS. 2 through 4 and FIGS. 8 and 9.

Referring to FIG. 2, the ink-jet apparatus 20 fills the plurality of recessed cells 11 on the printing substrate 10 with the color filter inks 25a, 25b and 25c. The different colors of color filter inks 25a, 25b and 25c may be filled in the recessed cells 11 at the same time, or independently by separate ink-jet processes (see FIG. 4).

Referring to FIG. 3, the flattening plate 30 flattens the color filter inks 25a, 25b and 25c on the surface of the printing substrate (see FIG. 4).

Referring to FIG. 4, the roller 40 rolls to transfer the color filter inks 25a, 25b and 25c on the surface of the printing substrate 10 to the roller 40.

The width of the recessed cells 11 on the printing substrate 10 (see FIG. 1) is provided to be the same as or larger than a space between the black matrixes 220 on the insulating substrate 210 so that the color filter inks 25a, 25b and 25c filled in the recessed cells 11 may be transferred to fill the space between the black matrixes 220, thereby obtaining a clear image.

The total length of the recessed cells 11 in the first through third lines may depend on the size of the LCD panel, i.e., the total length of the recessed cells 11 becomes long as the size of the LCD panel becomes big. Likewise, the number of the recessed cells 11 is proportional to the size of the LCD panel. The depth of the recessed cells 11 is the same or a little higher than the black matrix 220 on the insulating substrate 210 so that the color filter inks 25a, 25b and 25c may be formed. In the present exemplary embodiment, the different colors of color filter inks 25a, 25b and 25c may be filled in the recessed cells 11 by an ink-jet method at the same time, thereby simplifying a process and reducing processing hour.

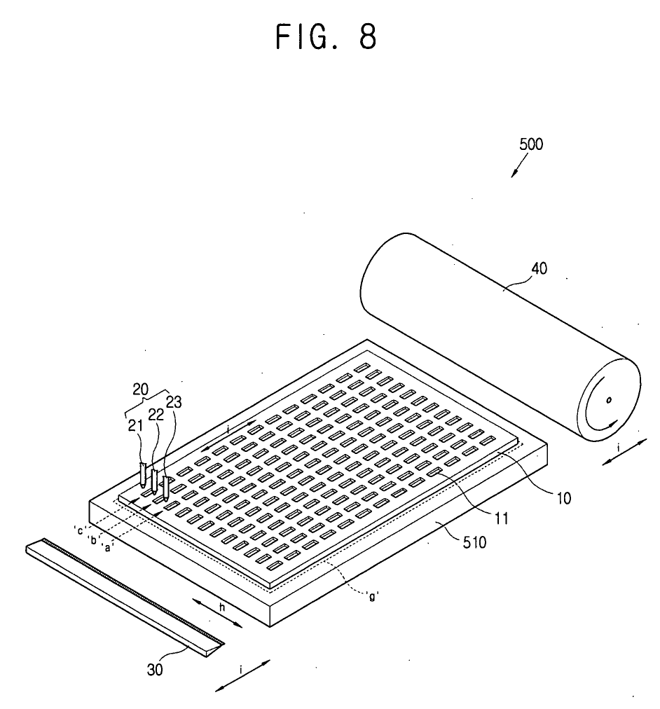

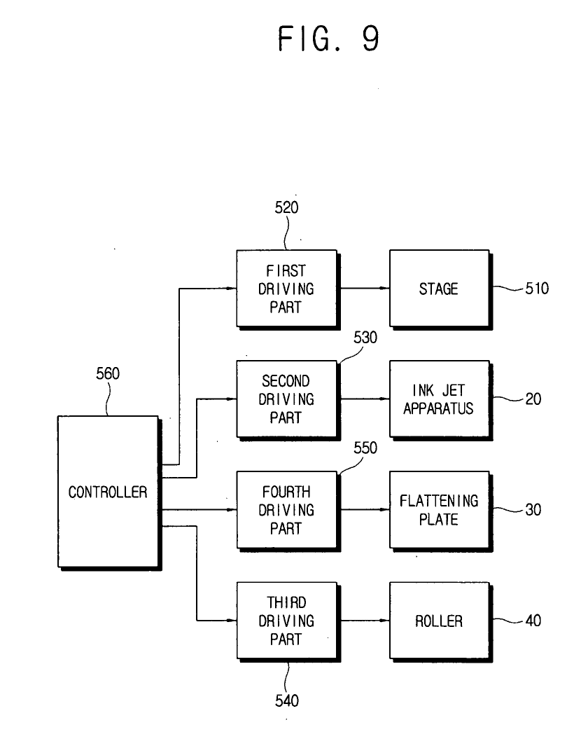

Referring to FIG. 8, the roller 40 with the color filter inks 25a, 25b and 25c thereon rolls on the insulating substrate 210 where the black matrix 220 is formed to transfer the color filter inks 25a, 25b and 25c to a space between the black matrixes 220. Accordingly, referring to FIG. 9, the color filter layer 230a, 230b and 230c having three different colors of filters is formed. The three different colors of filters 230a, 230b and 230c are formed at the same time, thereby reducing processing hour and improving a yield.

Then, the color filter substrate are fabricated by a known method and joined with the TFT substrate, and the liquid crystal layer is interposed therebetween, thereby completing the LCD panel.

Hereinafter, a printing apparatus according to the exemplary embodiment will be described with reference to FIGS. 2, 10 and 11.

A printing apparatus 500 according to the exemplary embodiment includes a stage 510 where a printing substrate with a plurality of recessed cells 11 is seated; an ink jet apparatus 20 having a plurality of nozzle heads 21, 22 and 23 to jet ink to the recessed cells 11; a flattening plate 30 to flatten the ink in the recessed cells 11; a roller 40 transferring the inks 40 in the recessed cells 11 to an insulating substrate 50 (see FIG. 5); a first through fourth driving parts 520, 530, 540 and 550 to drive the stage 510, the ink jet apparatus 20, the flattening plate 30 and the roller 40; and a controller 560 to control the first through fourth driving parts 520, 530, 540 and 550.

The stage 510 has a seating region (g) where the printing substrate 10 is seated and may move in a first direction (h). The ink jet apparatus 20 moves relatively to the stage 510 to jet and fill in the recessed cells 11 with the ink. The ink jet apparatus 20 may move in a second direction (i) relatively to the first direction in which the stage 510 moves. Alternatively, one of the stage 510 and the ink jet apparatus 20 may be fixed and the other thereof may move in the first direction (h) or in the second direction (i). The stage 510 and the ink jet apparatus 20 moves according to operations of the first and second driving parts 520 and 530. The controller 560 controls the first and second driving parts 520 and 530 to accurately jet the ink in the recessed cells 11.

The flattening plate 30 is provided as a plate member extending in one direction and disposed at a side of the printing substrate 10. The flattening plate 30 moves closely on the surface of the printing substrate 10 to flatten the ink in the recessed cells 11 and to remove the ink overflowed outside from the recessed cells 11. The flattening plate 30 includes a blade and may move upward, downward and in the second direction (i).

The circumference of the roller 40 is substantially the same as the length of the printing substrate 10 in a moving direction of the roller 40, and the width of the roller 40 is substantially the same as the of the width of the printing substrate 10 in a transverse direction to the moving direction of the roller 40. The roller 40 rolls closely on the surface of the printing substrate 10 so that the ink in the recessed cells 11 may be transferred to the roller 40. The roller 40 may move upward, downward and in the second direction (i).

Hereinafter, a driving method of the printing apparatus 20 will be described. When the printing substrate 10 is seated on the stage 510, the ink jet apparatus 20 is disposed close to a side of the printing substrate 10. Here, the first through third nozzle heads 21, 22 and 23 are disposed corresponding to the recessed cells 11 where the ink is jetted.

The first through third nozzle heads 21, 22 and 23 move over the surface of the printing substrate 10 in the second direction (i) to fill the recessed cells 11 disposed in the different lines (a), (b) and (c) with the ink. For example, as shown in FIG. 2, the first recessed cells 11 disposed in the first line (a) is filled with red ink 25a, the second recessed cells 11 disposed in the second line (b) is filled with green ink 25b, and the third recessed cells 11 disposed in the third line (c) is filled with blue ink 25c.

Alternatively, the stage 510 may move in the first direction (h) or second direction (i) to fill the recessed cells 11 with the ink, without moving the ink jet apparatus 20. The ink jet apparatus 20 may fill the first through third recessed cells 11 with different colors of inks 25a, 25b and 25c, respectively in independent processes. As described above, the jetting position and the jetting amount are not required to be as accurate as those in the conventional ink-jet method, and thus an increased jetting speed reduces a processing hour and enhances a yield.

When the recessed cells 11 are filled with the ink, the second driving part 530 moves the ink jet apparatus 20 out of a processing space.

Referring to FIG. 3, the controller 560 controls the fourth driving part 550 so that the flattening plate 30 moves closely on the surface of the printing substrate to flatten the ink in the recessed cells 11 and to remove the ink overflowed outside from the recessed cells 11.

Subsequently, the controller 560 controls the third driving part 540 so that the roller 40 rolls closely on the surface of the printing substrate 10. Accordingly, referring to FIG. 4, the ink in the recessed cells 11 is transferred to the roller 40. When the ink is transferred to the roller 40, the controller 560 controls the third driving part 540 to transport the roller 40 over the insulating substrate 50 to which the ink transferred. The roller 40 rolls on the insulating substrate 50 to transfer the ink to the insulating substrate 50, thereby forming a pattern on the insulating substrate 50 (see FIG. 5). Accordingly, the printing apparatus can simplify a process and improve a yield.

The aforementioned exemplary embodiment is described with a manufacturing method of a color filter substrate of an LCD panel as an example, but it is not limited thereto. The present exemplary embodiment may be employed to form an organic material or a polymer of an organic light emitting diodes (OLED) on predetermined regions between electrodes. Further, the present exemplary embodiment may also be employed to form a color filter layer on a TFT substrate, which is a color on array (COA).

It will be apparent to those skilled in the art that various modifications and variations can be made in the present invention without departing from the spirit or scope of the invention. Thus it is intended that the present invention cover the modifications and variations of this invention provided they come within the scope of the appended claims and their equivalents.

What is claimed is:

1. A gravure printing method comprising:
providing a printing substrate where a plurality of recessed cells are formed adjacently each other;
filling the recessed cells with ink using an ink jet apparatus which includes a plurality of nozzle heads to jet different colors of inks; and
transferring the ink in the recessed cells to an insulating substrate.

2. The gravure printing method according to claim 1, wherein the transferring the ink in the recessed cells to the insulating substrate comprises transferring the ink in the recessed cells to a roller by rolling the roller on a surface of the printing substrate; and
transferring the ink on the roller to the insulating substrate.

3. The gravure printing method according to claim 2, wherein the ink jet apparatus comprises a plurality of nozzle units which have a first nozzle head to jet red ink, a second nozzle head to jet green ink, and a third nozzle head to jet blue ink, and wherein the nozzle units move over the surface of the printing substrate to fill the recessed cells with red ink, green ink and blue ink, respectively.

4. The gravure printing method according to claim 3, further comprising flattening the ink on the surface of the printing substrate after filling the recessed cells with the ink.

5. The gravure printing method according to claim 4, wherein the flattening comprises progressing a flattening plate closely over the surface of the printing substrate.

6. The gravure printing method according to claim 5, wherein the flattening plate progresses parallel to the direction in which the recessed cells are extended.

7. The gravure printing method according to claim 5, wherein the flattening plate comprises a blade.

8. The gravure printing method according to claim 5, wherein the different colors of inks have such a viscosity as not to mix with each other when being filled into the recessed cells.

9. The gravure printing method according to claim 5, wherein the different colors of inks are injected from the plurality of nozzle heads into the recessed cells at such pressure that the different colors of inks do not mix with each other.

10. A manufacturing method of a display device comprising:
providing a printing substrate where a plurality of recessed cells are formed adjacently each other;
filling the recessed cells with ink using an ink jet apparatus which includes at least one nozzle head; and
transferring the ink in the recessed cells to an insulating substrate.

11. The manufacturing method according to claim 10, wherein the recessed cells comprises a first through third recessed cells disposed along a first through third lines respectively, and
different colors of inks are filled in the first through third recessed cells at the same time or sequentially.

12. The manufacturing method according to claim 11, wherein a black matrix having an opening pattern is provided on the insulating substrate, and the ink in the recessed cells is transferred into the opening pattern.

13. The manufacturing method according to claim 12, wherein the transferring of the ink to the insulating substrate comprises transferring the ink in the recessed cells to a roller that is progressing closely over the surface of the printing substrate; and
transferring the ink on the roller to the opening pattern.

14. The manufacturing method according to claim 11, further comprising flattening the ink on the surface of the printing substrate and removing the ink disposed outside of the recessed cells by progressing the flattening plate closely over the surface of the printing substrate after filling the recessed cells with the ink.

15. A printing apparatus comprising:
a stage including a seating region where a printing substrate with a plurality of recessed cells is seated;
an ink jet apparatus including a plurality of nozzle heads to jet ink to the recessed cells;
a roller transferring the ink in the recessed cells to an insulating substrate;
a first through third driving parts to drive the stage, the ink jet apparatus and the roller respectively; and
a controller to control the first through third driving parts.

16. The printing apparatus according to claim 15, further comprising a flattening plate which flattens the ink in the recessed cells and removes ink overflowed outside the recessed cells; and
a fourth driving part to drive the flattening plate,
wherein the controller controls the fourth driving part.

17. The printing apparatus according to claim 16, wherein the recessed cells comprises a first through third recessed cells provided along a first through third lines, and
the ink jet apparatus jets different colors of inks to the first through third recessed cells at the same time.

18. The printing apparatus according to claim 16, wherein the recessed cells comprises a first through third recessed cells provided along a first through third lines, and
the ink jet apparatus jets different colors of inks to the first through third recessed cells in a separate process, respectively.

19. The printing apparatus according to claim 17, wherein the ink jet apparatus jets the ink from the plurality of nozzle heads to the recessed cells at such pressure that the different colors of inks do not mix with each other when filling in the recessed cells.

20. The printing apparatus according to claim 18, wherein the ink jet apparatus jets the ink from the plurality of nozzle heads to the recessed cells at such pressure that the different colors of inks do not mix with each other when filling in the recessed cells.
